(19) United States
(12) Patent Application Publication
(10) Pub. No.: US 2026/0302275 A1
(43) Pub. Date: Oct. 1, 2026

(54) FUEL CELL

(71) Applicant: TOYOTA JIDOSHA KABUSHIKI KAISHA, Toyota-shi (JP)

(72) Inventors: Yutaka ISA, Miyoshi-shi (JP); Tohru ODA, Toyota-shi (JP)

(73) Assignee: TOYOTA JIDOSHA KABUSHIKI KAISHA, Toyota-shi (JP)

(21) Appl. No.: 19/577,987

(22) Filed: Mar. 25, 2026

(30) Foreign Application Priority Data
Mar. 28, 2025 (JP) 2025-055458

(51) Int. Cl. H01M 8/0276; H01M 8/00; H01M 8/0247; H01M 8/10

(52) U.S. Cl. CPC H01M 8/0276; H01M 8/002; H01M 8/0247; H01M 8/10

(57) ABSTRACT

A fuel cell comprises: a membrane electrode gas diffusion layer assembly including a membrane electrode assembly; a sheet member; and an adhesive layer that adhesively connects the membrane electrode assembly and the sheet member to each other. The adhesive layer is provided at an outer peripheral portion of the membrane electrode assembly. The adhesive layer includes a first adhesive part and a second adhesive part positioned on opposite sides of a power generation region of the membrane electrode assembly. The first adhesive part and the second adhesive part are located on a lower side and an upper side respectively with respect to the power generation region in a use situation of the fuel cell. In the use situation, the first adhesive part has a width in an upper-lower direction larger than a width of the second adhesive part in the upper-lower direction.

### CROSS REFERENCE TO RELATED APPLICATIONS

The present application claims priority from Japanese patent application No. P2025-55458 filed on Mar. 28, 2025, the disclosure of which is hereby incorporated in its entirety by reference into the present application.

### BACKGROUND

### Field

The present disclosure relates to a fuel cell.

### Related Art

There is a known fuel cell including a membrane electrode assembly where electrode catalyst layers are formed on both sides of an electrolyte membrane in the Japanese Patent Application Publication No. 2016-126911. The fuel cell generates power in response to electrochemical reaction between a fuel gas and an oxidizing gas.

Water generated during power generation by the fuel cell is likely to stay in the form of liquid on a lower side of the fuel cell. At an end portion of a separator not having been subjected to surface treatment for anticorrosion or for conductivity improvement, the generated water staying in a lower end portion of the fuel cell might cause leaching of a metallic material as a base material of the separator. The leached metallic material might degrade the electrolyte membrane of the membrane electrode assembly.

### SUMMARY

According to one aspect of the present disclosure, a fuel cell is provided. The fuel cell comprises: a membrane electrode gas diffusion layer assembly including a membrane electrode assembly; a sheet member that holds the membrane electrode gas diffusion layer assembly; and an adhesive layer that adhesively connects the membrane electrode assembly and the sheet member to each other. The adhesive layer is provided at an outer peripheral portion of the membrane electrode assembly. The adhesive layer includes a first adhesive part and a second adhesive part positioned on opposite sides of a power generation region of the membrane electrode assembly. The first adhesive part and the second adhesive part are located on a lower side and an upper side respectively with respect to the power generation region in a use situation of the fuel cell. In the use situation, the first adhesive part has a width in an upper-lower direction larger than a width of the second adhesive part in the upper-lower direction.

### BRIEF DESCRIPTION OF THE DRAWINGS

FIG. 1 is an exploded perspective view of a fuel cell according to a first embodiment;

FIG. 2 is a plan view of a sheet member according to the first embodiment;

FIG. 3 is a sectional view of the fuel cell according to the first embodiment; and

FIG. 4 is a sectional view of a fuel cell according to a second embodiment.

### DETAILED DESCRIPTION

### A. FIRST EMBODIMENT

### A1. Overall Configuration of Fuel Cell 10

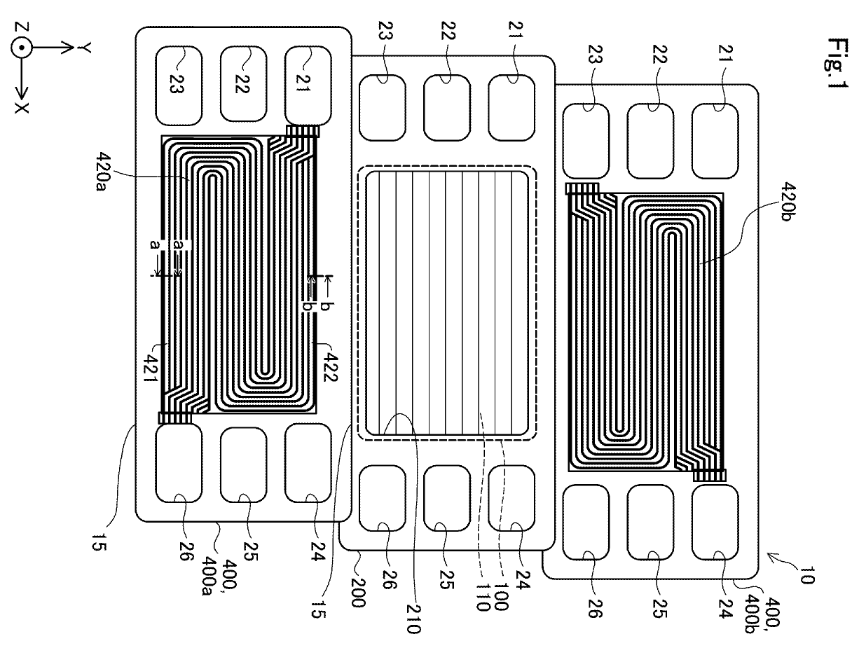

FIG. 1 is an exploded perspective view of a fuel cell 10 according to a first embodiment. The fuel cell 10 is configured as a solid polymer fuel cell. The fuel cell 10 generates power in response to electrochemical reaction between an anode gas and a cathode gas. The anode gas is a fuel gas such as hydrogen, and the cathode gas is air containing an oxidizing gas such as oxygen. The anode gas and the cathode gas are also called “reaction gases” collectively.

An X axis, a Y axis, and a Z axis perpendicular to each other are shown in FIGS. 1-3 for explaining the present embodiment. The X direction is a direction conforming to a lengthwise direction of the fuel cell 10. The Y direction is a direction conforming to a short-side direction of the fuel cell 10. The Z direction is a direction conforming to a thickness direction of the fuel cell 10. The Z direction also agrees with a direction of stacking a plurality of the fuel cells 10 for forming a fuel cell stack. In the present embodiment, a “right-left direction” corresponds to a direction along the X axis, and an “upper-lower direction” corresponds to a direction along the Y axis.

In the present embodiment, in a use situation where the fuel cell stack is used while installed on an installation target such as a vehicle, the +Y direction corresponds to a vertically-upper side (a direction of antigravitational force), and the -Y direction corresponds to a vertically-lower side (a direction of gravitational force). When viewed in the Z direction, the fuel cell 10 is formed into a rectangular shape with long sides 15 in a pair parallel to each other. In the use situation of the fuel cell 10, the long sides 15 in a pair are located on a vertically-lower side and a vertically-upper side respectively with respect to a power generation region Ar1 described later.

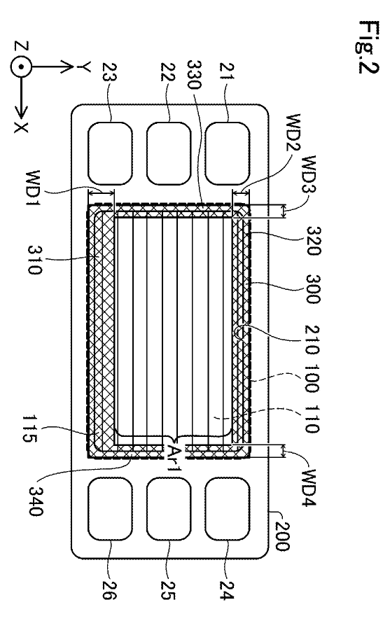

FIG. 2 is a plan view of a sheet member 200 according to the first embodiment. As shown in FIGS. 1 and 2, the fuel cell 10 includes a membrane electrode gas diffusion layer assembly (MEGA) 100, the sheet member 200, an adhesive layer 300, and separators 400 in a pair.

### Membrane Electrode Gas Diffusion Layer Assembly 100

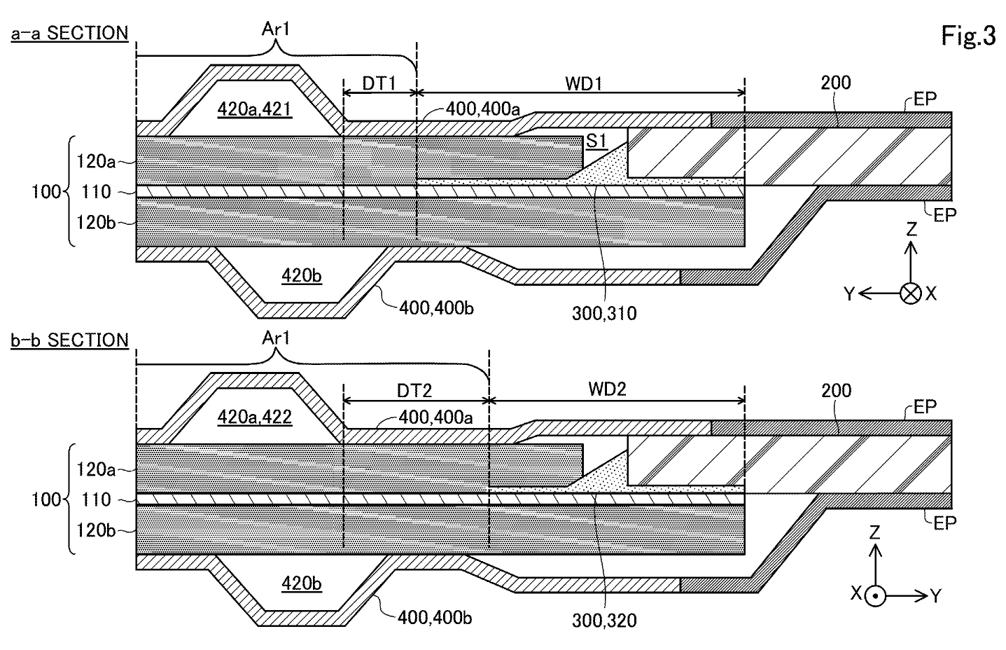

FIG. 3 is a sectional view of the fuel cell 10 according to the first embodiment. An upper part of FIG. 3 shows a sectional view of the fuel cell 10 cut along a position corresponding to a line a-a in FIG. 1 (hereinafter called a “a-a sectional view”). A lower part of FIG. 3 shows a sectional view of the fuel cell 10 cut along a position corresponding to a line b-b in FIG. 1 (hereinafter called a “b-b sectional view”). A configuration shown in the a-a sectional view and a configuration shown in the b-b sectional view differ from each other in a range of presence of the adhesive layer 300 described later. As shown in FIG. 3, the membrane electrode gas diffusion layer assembly 100 includes a membrane electrode assembly (MEA) 110, a cathode gas diffusion layer 120a formed on one surface of the membrane electrode assembly 110, and an anode gas diffusion layer 120b formed on the other surface of the membrane electrode assembly 110.

The membrane electrode assembly 110 includes an electrolyte membrane, a cathode catalyst layer arranged on one surface of the electrolyte membrane, and an anode catalyst layer arranged on the other surface of the electrolyte membrane. The electrolyte membrane is composed of an ion exchange membrane made of a fluorine-based resin, for example, and causes particular ions to be transmitted therethrough selectively. The cathode catalyst layer catalyzes electrochemical reaction on a cathode side. The anode catalyst layer catalyzes electrochemical reaction on an anode side. As shown in FIGS. 2 and 3, a center area of the membrane electrode assembly 110 forms the power generation region Ar1. The “power generation region Ar1” means a region where the electrolyte membrane and the catalyst layers of the both electrodes overlap each other and where electrochemical reaction using the reaction gases may occur. The cathode gas diffusion layer 120a and the anode gas diffusion layer 120b are each composed of a porous base material for diffusion layer having conductivity. The cathode gas diffusion layer 120a diffuses the cathode gas to supply the cathode gas to the cathode catalyst layer. The anode gas diffusion layer 120b diffuses the anode gas to supply the anode gas to the anode catalyst layer.

### Sheet Member 200

As shown in FIG. 2, the sheet member 200 is a rectangular frame having an opening 210 formed in a center area thereof. The opening 210 has a rectangular shape that is one size smaller than the membrane electrode gas diffusion layer assembly 100. The sheet member 200 is made of a resin material having electrical insulating property and air tightness. Examples of the resin material include polypropylene, phenol resin, epoxy resin, and polyethylene. The membrane electrode gas diffusion layer assembly 100 is adhesively connected via the adhesive layer 300 described later to one surface of the sheet member 200 in such a manner as to close the opening 210. In this way, the sheet member 200 holds the membrane electrode gas diffusion layer assembly 100.

### Adhesive Layer 300

As shown in FIG. 3, the adhesive layer 300 forms adhesive contact between the membrane electrode assembly 110 and the sheet member 200. The adhesive layer 300 is made of an adhesive agent having ultraviolet curing property to be cured with an ultraviolet ray. Examples of the adhesive agent to be used include an adhesive agent using radically polymerized resin or an adhesive agent using cationically polymerized resin. The adhesive agent may be configured as an adhesive agent having thermosetting property. The adhesive layer 300 will be described later in detail.

### Separators 400 in a Pair

As shown in FIGS. 1 and 3, the separators 400 in a pair interpose the membrane electrode gas diffusion layer assembly 100 therebetween. An outer peripheral portion of each separator 400 is adhesively connected to the sheet member 200 with an adhesive agent not shown in the drawings. The separators 400 in a pair include a cathode separator 400a as a separator 400 on the cathode side, and an anode separator 400b as a separator 400 on the anode side. The cathode separator 400a forms a plurality of cathode gas flow paths 420a between the cathode separator 400a and the membrane electrode gas diffusion layer assembly 100 for causing the cathode gas to pass therethrough. The anode separator 400b forms a plurality of anode gas flow paths 420b between the anode separator 400b and the membrane electrode gas diffusion layer assembly 100 for causing the anode gas to pass therethrough.

As shown in FIG. 3, each separator 400 is made of stainless steel having been subjected to surface treatment. The “surface treatment” means depositing titan for suppressing corrosion of stainless steel or depositing carbon for improving conductivity on a surface of each separator 400, for example. An exemplary method of the deposition is physical vapor deposition (PVD). Meanwhile, performing the above surface treatment on each separator 400 significantly reduces adhesiveness to the sheet member 200. In response to this, as shown in FIG. 3, the outer peripheral portion of each separator 400 has an exposed part EP not having been subjected to the above surface treatment, namely, the exposed part EP where stainless steel is exposed. By doing so, adhesiveness of each separator 400 to the sheet member 200 is ensured.

As shown in FIG. 1, each separator 400 and the sheet member 200 each have manifolds 21 to 26. The manifolds 21 to 26 are formed as manifold holes for passage of the cathode gas, the anode gas, or cooling liquid. In a stacking direction of a plurality of the fuel cells 10, forming positions overlap each other between the manifolds 21, between the manifolds 22, between the manifolds 23, between the manifolds 24, between the manifolds 25, and between the manifolds 26.

The cathode gas is supplied from the manifold 21. The supplied cathode gas is distributed to the cathode side of the fuel cell 10. The distributed cathode gas passes through the cathode gas flow path 420a formed between the membrane electrode gas diffusion layer assembly 100 and the cathode separator 400a. Part of the distributed cathode gas not having been used for power generation is discharged from the manifold 26.

The anode gas is supplied from the manifold 24. The supplied anode gas is distributed to the anode side of the fuel cell 10. The distributed anode gas passes through the anode gas flow path 420b formed between the membrane electrode gas diffusion layer assembly 100 and the anode separator 400b. Part of the distributed anode gas not having been used for power generation is discharged from the manifold 23.

The cooling liquid is supplied from the manifold 22. The supplied cooling liquid is distributed to between the fuel cells 10 next to each other among the stacked fuel cells 10. The distributed cooling liquid passes through a cooling liquid flow path formed between the cathode separator 400a and the anode separator 400b of the fuel cells 10 next to each other. The distributed cooling liquid is discharged from the manifold 25.

At the cathode gas flow path 420a, hydrogen ions generated at the anode gas flow path 420b and having been transmitted through the electrolyte membrane react with the cathode gas, thereby generating water in the form of liquid. While much of the generated water is discharged from the manifold 26 via the cathode gas flow path 420a, part of the generated water stays inside the cathode gas flow path 420a on a vertically-lower side with respect to the power generation region Ar1. The staying generated water might be retained in space S1 shown in FIG. 3 on a vertically-lower side with respect to the power generation region Ar1, and this might cause leaching of a metallic material in the exposed part EP not having been subjected to the surface treatment. As shown in FIG. 3, the “space S1” means space defined on a vertically-lower side with respect to the power generation region Ar1, and surrounded by the cathode separator 400a, the cathode gas diffusion layer 120a, the sheet member 200, and the membrane electrode assembly 110. If the leached metallic material is taken into the electrolyte membrane of the membrane electrode assembly 110, the electrolyte membrane might be degraded. The degradation of the electrolyte membrane might further result in a situation where the cathode gas or the anode gas is transmitted through the electrolyte membrane to cause reaction between the cathode gas and the anode gas, and oxygenated water resulting from the reaction develops the degradation of the electrolyte membrane further. In the present embodiment, such degradation of the electrolyte membrane is suppressed by making adjustment such as that of a range of presence of the adhesive layer 300, as described later.

### A2. Detailed Configuration of Adhesive Layer 300

As shown in FIG. 2, the adhesive layer 300 has a frame shape provided at an outer peripheral portion 115 of the membrane electrode assembly 110. The adhesive layer 300 includes a first adhesive part 310 and a second adhesive part 320 positioned on opposite sides of the power generation region Ar1. The first adhesive part 310 and the second adhesive part 320 face each other at the adhesive layer 300 having a frame shape, and are located on a vertically-lower side and a vertically-upper side respectively with respect to the power generation region Ar1 in a use situation of the fuel cell 10. The first adhesive part 310 and the second adhesive part 320 both have strip shapes extending in the right-left direction. In the present embodiment, the first adhesive part 310 and the second adhesive part 320 both have constant widths in the upper-lower direction. As shown in FIGS. 2 and 3, the width of the first adhesive part 310 in the upper-lower direction is called a “first width WD1,” and the width of the second adhesive part 320 in the upper-lower direction is called a “second width WD2.” The first width WD1 is larger than the second width WD2.

As described above, the generated water staying in the space S1 may cause leaching of the metallic material from the exposed part EP not having been subjected to the surface treatment. Even in this case, however, the first adhesive part 310 having the first width WD1 larger than the second width WD2 has a higher possibility of preventing the metallic material leached out from contacting the membrane electrode assembly 110, compared to a configuration where the first width WD1 is smaller than the second width WD2. This makes it possible to reduce the occurrence of taking the leached metallic material into the electrolyte membrane.

As shown in the a-a sectional view in FIG. 3, the length of the exposed part EP of the cathode separator 400a in the upper-lower direction is smaller than the length of the exposed part EP of the anode separator 400b in the upper-lower direction. This makes it possible to reduce the occurrence itselt of leaching of the metallic material from the exposed part EP of the cathode separator 400a.

As shown in FIG. 3, the adhesive layer 300 is interposed between the membrane electrode assembly 110 and the sheet member 200, and is further interposed between the membrane electrode assembly 110 and the cathode gas diffusion layer 120a and between the sheet member 200 and the cathode gas diffusion layer 120a. As shown in FIG. 3, in the present embodiment, the adhesive layer 300 interposed between the membrane electrode assembly 110 and the sheet member 200 has a thickness in the Z direction and the adhesive layer 300 interposed between the membrane electrode assembly 110 and the cathode gas diffusion layer 120a has a thickness in the Z direction that are both substantially constant. On the other hand, the adhesive layer 300 interposed between the sheet member 200 and the cathode gas diffusion layer 120a is formed in such a manner that the thickness of the adhesive layer 300 in the Z direction increases toward a vertically-lower side in the a-a sectional view, and is formed in such a manner that the thickness of the adhesive layer 300 in the Z direction increases toward a vertically-upper side in the b-b sectional view. As a result, the sheet member 200 is adhesively connected more stably to the membrane electrode assembly 110 via the adhesive layer 300.

As shown in FIG. 3, the first adhesive part 310 is positioned on a vertically-lower side with respect to a first flow path 421 that is located at a lowermost position among the plurality of cathode gas flow paths 420a in the use situation of the fuel cell 10. The second adhesive part 320 is positioned on a vertically-upper side with respect to a second flow path 422 that is located at an uppermost position among the plurality of cathode gas flow paths 420a in the use situation of the fuel cell 10. In this way, in the first embodiment, the first adhesive part 310 and the first flow path 421 do not overlap each other in the upper-lower direction. Likewise, the second adhesive part 320 and the second flow path 422 do not overlap each other in the upper-lower direction. Thus, it is possible to make it less likely that supply of the cathode gas to the membrane electrode assembly 110 will be inhibited by the presence of the adhesive layer 300.

A distance in the upper-lower direction from the first adhesive part 310 to the first flow path 421 is called a “first distance DT1.” A distance in the upper-lower direction from the second adhesive part 320 to the second flow path 422 is called a “second distance DT2.” In the present embodiment, the first distance DT1 is constant in the right-left direction entirely. The second distance DT2 is constant in the right-left direction entirely. As shown in FIG. 3, the first distance DT1 is shorter than the second distance DT2.

In some cases, the generated water staying in the space S1 causes leaching of the metallic material from the exposed part EP not having been subjected to the surface treatment, and the leached metallic material is taken into the electrolyte membrane of the membrane electrode assembly 110 to degrade the electrolyte membrane. Even in this case, as the first distance DT1 is shorter than the second distance DT2 in the present embodiment, it is still possible to make it less likely using the presence of the first adhesive part 310 that the reaction gas will be transmitted through a degraded part of the electrolyte membrane to move between the first flow path 421 and the anode gas flow path 420b. Furthermore, compared to a region on a vertically-lower side with respect to the power generation region Ar1, in a region on a vertically-upper side with respect to the power generation region Ar1, degradation of the electrolyte membrane due to the generated water is considered not likely to occur, so that it is not considered that the reaction gas will be transmitted through the electrolyte membrane to move between the first flow path 421 and the anode gas flow path 420b. This allows the second distance DT2 to be longer than the first distance DT1, so that it is possible to make it less likely that supply of the cathode gas to the membrane electrode assembly 110 will be inhibited by the presence of the second adhesive part 320.

As shown in FIG. 2, the adhesive layer 300 further includes a third adhesive part 330 located on the left side and a fourth adhesive part 340 located on the right side positioned on opposite sides of the power generation region Ar1. In the present embodiment, the third adhesive part 330 and the fourth adhesive part 340 both have strip shapes extending in the upper-lower direction. In the present embodiment, the third adhesive part 330 and the fourth adhesive part 340 both have constant widths in the right-left direction. The width of the third adhesive part 330 in the right-left direction is called a “third width WD3,” and the width of the fourth adhesive part 340 in the right-left direction is called a “fourth width WD4.” The third width WD3 and the fourth width WD4 are substantially equal to each other. The third width WD3 and the fourth width WD4 are smaller than the first width WD1. The third width WD3 and the fourth width WD4 are smaller than the second width WD2.

The cathode gas flow paths 420a at a left end portion and a right end portion of the cathode separator 400a are formed in such a manner as to cause the generated water to pass therethrough toward a direction of gravitational force. Thus, compared to a region on a vertically-lower side with respect to the power generation region Ar1, in a region on the left side or right side with respect to the power generation region Ar1, the generated water is unlikely to stay, so that leaching of the metallic material from the exposed part EP or degradation of the electrolyte membrane is considered not likely to occur. This allows the third width WD3 and the fourth width WD4 to be smaller than the first width WD1, making it possible to reduce the used amount of the adhesive agent for forming the adhesive layer 300.

According to the fuel cell 10 described above, the first width WD1 showing the width of the first adhesive part 310 in the upper-lower direction is larger than the second width WD2 showing the width of the second adhesive part 320 in the upper-lower direction. Thus, even if the generated water staying on a vertically-lower side with respect to the power generation region Ar1 causes leaching of the metallic material from the exposed part EP, it is still possible to reduce the occurrence of taking the leached metallic material into the electrolyte membrane of the membrane electrode assembly 110. As a result, it is possible to suppress degradation of the electrolyte membrane. Furthermore, compared to a region on a vertically-lower side with respect to the power generation region Ar1, in a region on a vertically-upper side with respect to the power generation region Ar1, the generated water is unlikely to stay, so that leaching of the metallic material from the exposed part EP or degradation of the electrolyte membrane is considered not likely to occur. This allows the second width WD2 to be smaller than the first width WD1, making it possible to reduce the used amount of the adhesive agent for forming the adhesive layer 300.

In the use situation of the fuel cell 10, the long sides 15 in a pair are located on a vertically-lower side and a vertically-upper side respectively with respect to the power generation region Ar1. This allows the fuel cell 10 to be used in a stably-installed condition.

The first distance DT1 showing the distance in the upper-lower direction from the first adhesive part 310 to the first flow path 421 is shorter than the second distance DT2 showing the distance in the upper-lower direction from the second adhesive part 320 to the second flow path 422. Thus, even if the electrolyte membrane of the membrane electrode assembly 110 is degraded, it is still possible to make it less likely using the presence of the first adhesive part 310 that the reaction gas will be transmitted through the electrolyte membrane to move between the first flow path 421 and the anode gas flow path 420b. Furthermore, compared to a region on a vertically-lower side with respect to the power generation region Ar1, in a region on a vertically-upper side with respect to the power generation region Ar1, degradation of the electrolyte membrane is considered not likely to occur, so that it is not considered that the reaction gas will be transmitted through the electrolyte membrane to move between the first flow path 421 and the anode gas flow path 420b. This allows the second distance DT2 to be longer than the first distance DT1, so that it is possible to make it less likely that supply of the cathode gas to the membrane electrode assembly 110 will be inhibited by the presence of the second adhesive part 320.

### B. SECOND EMBODIMENT

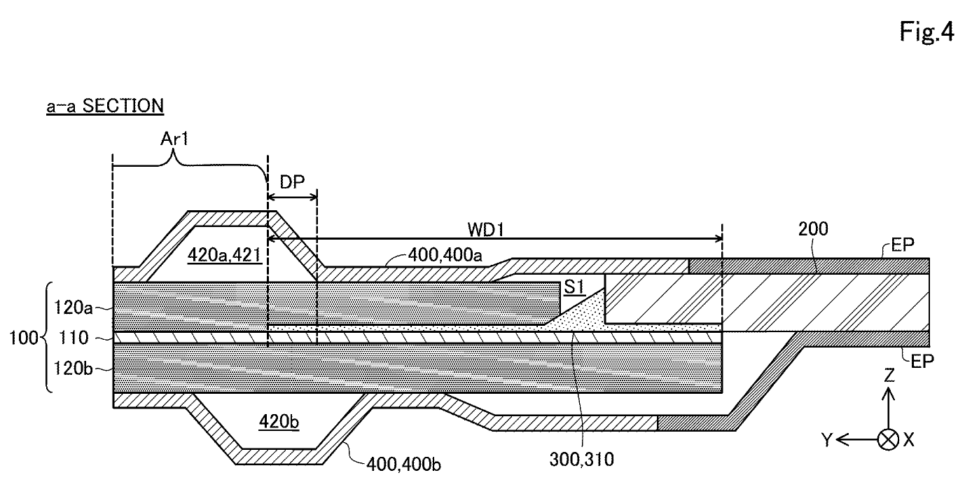

FIG. 4 is a sectional view of a fuel cell 10 according to a second embodiment. FIG. 4 corresponds to a sectional view taken along a-a in FIG. 1. The fuel cell 10 of the second embodiment differs from the fuel cell 10 of the first embodiment only in a range of presence of the first adhesive part 310. A structure same as that of the first embodiment will be given the same sign, and detailed description thereof will be omitted.

As shown in FIG. 4, the first adhesive part 310 partially overlaps the first flow path 421 in the upper-lower direction that is located at the lowermost position among the plurality of cathode gas flow paths 420a in the use situation of the fuel cell 10. A width where the first adhesive part 310 overlaps the first flow path 421 in the upper-lower direction is called an “overlapping width DP.” The overlapping width DP is smaller than the width of the first flow path 421 in the upper-lower direction. An upper end portion of the first adhesive part 310 may be located on an upper side with respect to an upper end portion of the first flow path 421. In this case, the overlapping width DP becomes equal to the width of the first flow path 421 in the upper-lower direction.

As described above, unlike in the first embodiment, the first adhesive part 310 partially overlaps the first flow path 421 in the upper-lower direction in the second embodiment. This causes a probability that, compared to the first embodiment, supply of the cathode gas to the membrane electrode assembly 110 will be inhibited by the presence of the first adhesive part 310. In the second embodiment, however, as the first adhesive part 310 partially overlaps the first flow path 421 in the upper-lower direction, it is possible to more effectively make it less likely using the presence of the first adhesive part 310 than in the first embodiment that the reaction gas will be transmitted through the electrolyte membrane to move between the first flow path 421 and the anode gas flow path 420b.

The fuel cell 10 described above achieves effects comparable to those of the fuel cell 10 of the first embodiment. Furthermore, the first adhesive part 310 partially overlaps the first flow path 421 in the upper-lower direction that is located at the lowermost position among the plurality of cathode gas flow paths 420a in the use situation of the fuel cell 10. Thus, even if the electrolyte membrane of the membrane electrode assembly 110 is degraded, it is still possible to more effectively make it less likely using the presence of the first adhesive part 310 that the reaction gas will be transmitted through the electrolyte membrane to move between the first flow path 421 and the anode gas flow path 420b.

### C. OTHER EMBODIMENTS

C1. In each of the embodiments, in the use situation of the fuel cell 10, the long sides 15 in a pair of the fuel cell 10 are located on a vertically-lower side and a vertically-upper side respectively with respect to the power generation region Ar1. However, the present disclosure is not limited to this. The fuel cell 10 may be tilted at an arbitrary angle of less than 90° from a vertically-upper side or vertically-lower side. Specifically, as long as the long sides 15 in a pair of the fuel cell 10 are located on a lower side and an upper side with respect to the power generation region Ar1 in the use situation of the fuel cell 10, they are not required to be located on a vertically-lower side and a vertically-upper side. Likewise, the present disclosure may be implemented in a case where a vertically-lower side and a vertically-upper side in each of the embodiments are replaced by an “upper side” and a “lower side” respectively.

C2. While the first adhesive part 310 and the second adhesive part 320 both have constant widths in the upper-lower direction in each of the embodiments, they are not required to have constant widths in the upper-lower direction. In this case, the first width WD1 corresponds to the width of the first adhesive part 310 extending in the right-left direction in an area where the first adhesive part 310 is narrowest in the upper-lower direction. Likewise, the second width WD2 corresponds to the width of the second adhesive part 320 extending in the right-left direction in an area where the second adhesive part 320 is narrowest in the upper-lower direction.

C3. While the third adhesive part 330 and the fourth adhesive part 340 both have constant widths in the right-left direction, they are not required to have constant widths in the right-left direction. In this case, the third width WD3 corresponds to the width of the third adhesive part 330 extending in the upper-lower direction in an area where the third adhesive part 330 is narrowest in the right-left direction. Likewise, the fourth width WD4 corresponds to the width of the fourth adhesive part 340 extending in the upper-lower direction in an area where the fourth adhesive part 340 is narrowest in the right-left direction.

C4. While the first distance DT1 and the second distance DT2 are both constant in the right-left direction entirely in each of the embodiments, they are not required to be constant in the right-left direction entirely. In this case, the first distance DT1 corresponds to a distance from the first adhesive part 310 to the first flow path 421 in an area where this distance is shortest in the upper-lower direction. Likewise, the second distance DT2 corresponds to a distance from the second adhesive part 320 to the second flow path 422 in an area where this distance is shortest in the upper-lower direction.

C5. In the first embodiment, the first distance DT1 is shorter than the second distance DT2. However, the present disclosure is not limited to this. The first distance DT1 may be equal to the second distance DT2, or the first distance DT1 may be longer than the second distance DT2. The first distance DT1 may become longer than the second distance DT2 in a case where a distance from a lower end of the membrane electrode assembly 110 to the first flow path 421 is longer than a distance from an upper end of the membrane electrode assembly 110 to the second flow path 422, for example.

C6. In each of the embodiments, the adhesive layer 300 interposed between the membrane electrode assembly 110 and the sheet member 200 has a thickness in the Z direction and the adhesive layer 300 interposed between the membrane electrode assembly 110 and the cathode gas diffusion layer 120a has a thickness in the Z direction that are both substantially constant. However, the present disclosure is not limited to this. For example, the adhesive layer 300 interposed between the membrane electrode assembly 110 and the cathode gas diffusion layer 120a may be formed in such a manner that the thickness of the adhesive layer 300 decreases gradually toward the power generation region Ar1. This allows the cathode gas diffusion layer 120a to be arranged stably in conformity with the gradually-changing thickness of the adhesive layer 300.

The present disclosure is not limited to the embodiments described above and is able to be realized with various configurations without departing from the spirit thereof. For example, technical features in the embodiments corresponding to the technical features in the aspects described in the section of SUMMARY are able to be replaced with each other or combined together, as appropriate, in order to solve part or the whole of the problems described previously or to achieve part or the whole of the effects described previously. When the technical features are not described as essential features in the present specification, they are able to be deleted, as appropriate. The dimension of each member shown in the drawings may be different from an actual dimension thereof. The present disclosure may be realized in the following aspects, for example.
(1) According to one aspect of the present disclosure, a fuel cell is provided. The fuel cell comprises: a membrane electrode gas diffusion layer assembly including a membrane electrode assembly; a sheet member that holds the membrane electrode gas diffusion layer assembly; and an adhesive layer that adhesively connects the membrane electrode assembly and the sheet member to each other. The adhesive layer is provided at an outer peripheral portion of the membrane electrode assembly. The adhesive layer includes a first adhesive part and a second adhesive part positioned on opposite sides of a power generation region of the membrane electrode assembly. The first adhesive part and the second adhesive part are located on a lower side and an upper side respectively with respect to the power generation region in a use situation of the fuel cell. In the use situation, the first adhesive part has a width in an upper-lower direction larger than a width of the second adhesive part in the upper-lower direction. According to this aspect, the width of the first adhesive part in the upper-lower direction is larger than the width of the second adhesive part in the upper-lower direction. Thus, in a case where a separator forming the fuel cell contains a metallic material, even if generated water staying on a lower region with respect to the power generation region causes leaching of the metallic material from an end portion of the separator, it is still possible to reduce the occurrence of taking the leached metallic material into an electrolyte membrane of the membrane electrode assembly. Thus, it is possible to suppress degradation of the electrolyte membrane. Furthermore, compared to a region on a lower side with respect to the power generation region, in a region on an upper side with respect to the power generation region, the generated water is unlikely to stay, so that leaching of the metallic material from the end portion of the separator or degradation of the electrolyte membrane is considered not likely to occur. This allows the width of the second adhesive part in the upper-lower direction to be smaller than the width of the first adhesive part in the upper-lower direction, making it possible to reduce the used amount of an adhesive agent for forming the adhesive layer.
(2) In the above aspect, the fuel cell may be formed into a rectangular shape with long sides in a pair parallel to each other, and in the use situation, the long sides in a pair may be located on a lower side and an upper side respectively with respect to the power generation region. According to this aspect, in the use situation of the fuel cell, the long sides in a pair are located on a lower side and an upper side respectively with respect to the power generation region. This allows the fuel cell to be used in a stably-installed condition.
(3) In the above aspect, the fuel cell may further comprise separators in a pair that interpose the membrane electrode gas diffusion layer assembly therebetween. One separator of the separators in a pair may form a plurality of cathode gas flow paths between the one separator and the membrane electrode gas diffusion layer assembly for causing a cathode gas to pass therethrough. The first adhesive part may be positioned on a lower side with respect to a first flow path that is located at a lowermost position among the plurality of cathode gas flow paths in the use situation. The second adhesive part may be positioned on an upper side with respect to a second flow path that is located at an uppermost position among the plurality of cathode gas flow paths in the use situation. A distance in the upper-lower direction from the first adhesive part to the first flow path may be shorter than a distance in the upper-lower direction from the second adhesive part to the second flow path. According to this aspect, the distance in the upper-lower direction from the first adhesive part to the first flow path is shorter than the distance in the upper-lower direction from the second adhesive part to the second flow path. Thus, even if the electrolyte membrane of the membrane electrode assembly is degraded, it is still possible to make it less likely using the presence of the first adhesive part that a reaction gas will be transmitted through the electrolyte membrane to move between the first flow path and the anode gas flow path. Furthermore, compared to a region on a lower side with respect to the power generation region, in a region on an upper side with respect to the power generation region, degradation of the electrolyte membrane is considered not likely to occur, so that it is not considered that the reaction gas will be transmitted through the electrolyte membrane to move between the first flow path and the anode gas flow path. This allows the distance in the upper-lower direction from the second adhesive part to the second flow path to be longer than the distance in the upper-lower direction from the first adhesive part to the first flow path, so that it is possible to make it less likely that supply of the cathode gas to the membrane electrode assembly will be inhibited by the presence of the second adhesive part.
(4) In the above aspect, the fuel cell may further comprise separators in a pair that interpose the membrane electrode gas diffusion layer assembly therebetween. One separator of the separators in a pair may form a plurality of cathode gas flow paths between the one separator and the membrane electrode gas diffusion layer assembly for causing a cathode gas to pass therethrough. The first adhesive part may partially overlap a first flow path in the upper-lower direction that is located at a lowermost position among the plurality of cathode gas flow paths in the use situation. According to this aspect, the first adhesive part partially overlaps the first flow path in the upper-lower direction that is located at the lowermost position among the plurality of cathode gas flow paths in the use situation. Thus, even if the electrolyte membrane of the membrane electrode assembly is degraded, it is still possible to more effectively make it less likely using the presence of the first adhesive part that the reaction gas will be transmitted through the electrolyte membrane to move between the first flow path and the anode gas flow path.

What is claimed is:

1. A fuel cell comprising:
a membrane electrode gas diffusion layer assembly including a membrane electrode assembly;
a sheet member that holds the membrane electrode gas diffusion layer assembly; and
an adhesive layer that adhesively connects the membrane electrode assembly and the sheet member to each other, the adhesive layer being provided at an outer peripheral portion of the membrane electrode assembly, wherein
the adhesive layer includes a first adhesive part and a second adhesive part positioned on opposite sides of a power generation region of the membrane electrode assembly,
the first adhesive part and the second adhesive part are located on a lower side and an upper side respectively with respect to the power generation region in a use situation of the fuel cell, and
in the use situation, the first adhesive part has a width in an upper-lower direction larger than a width of the second adhesive part in the upper-lower direction.

2. The fuel cell according to claim 1, wherein
the fuel cell is formed into a rectangular shape with long sides in a pair parallel to each other, and
in the use situation, the long sides in a pair are located on a lower side and an upper side respectively with respect to the power generation region.

3. The fuel cell according to claim 1, further comprising:
separators in a pair that interpose the membrane electrode gas diffusion layer assembly therebetween, wherein
one separator of the separators in a pair forms a plurality of cathode gas flow paths between the one separator and the membrane electrode gas diffusion layer assembly for causing a cathode gas to pass therethrough,
the first adhesive part is positioned on a lower side with respect to a first flow path that is located at a lowermost position among the plurality of cathode gas flow paths in the use situation,
the second adhesive part is positioned on an upper side with respect to a second flow path that is located at an uppermost position among the plurality of cathode gas flow paths in the use situation, and
a distance in the upper-lower direction from the first adhesive part to the first flow path is shorter than a distance in the upper-lower direction from the second adhesive part to the second flow path.

4. The fuel cell according to claim 1, further comprising:
separators in a pair that interpose the membrane electrode gas diffusion layer assembly therebetween, wherein
one separator of the separators in a pair forms a plurality of cathode gas flow paths between the one separator and the membrane electrode gas diffusion layer assembly for causing a cathode gas to pass therethrough, and
the first adhesive part partially overlaps a first flow path in the upper-lower direction that is located at a lowermost position among the plurality of cathode gas flow paths in the use situation.
